(19) United States
(12) Patent Application Publication
(10) Pub. No.: US 2013/0191067 A1
(43) Pub. Date: Jul. 25, 2013

(54) Systems and Methods for Reliable Motion Control of Virtual Tour Applications

(71) Applicant: TourWrist, Inc., San Francisco, CA (US)

(72) Inventors: Kyle Brandon Reed, Tampa, FL (US); Brian Durwood Foshee, Coral Gables, FL (US); Charles Robert Armstrong, San Francisco, CA (US)

(73) Assignee: TOURWRIST, INC., San Francisco, CA (US)

(21) Appl. No.: 13/733,906

(22) Filed: Jan. 4, 2013

Related U.S. Application Data
(60) Provisional application No. 61/584,171, filed on Jan. 6, 2012.

(51) Int. Cl. G01P 3/44

(52) U.S. Cl. CPC G01P 3/44
USPC 702/141; 702/147

(57) ABSTRACT

The present invention relates to systems and methods for reliably detecting motion control of mobile devices executing virtual tour applications. In one embodiment, a computerized mobile device reliably detects angular rotations. The mobile device includes a magnetometer for generating directional values representing the respective angular rotations. The mobile device detects abrupt change(s) in additional directional values relative to the prior directional values, and if an abrupt change in an additional directional value is detected, then an appropriate weight is assigned to the additional data value. In addition to generating directional values, the magnetometer may also generate corresponding magnitude values. The mobile device evaluates the corresponding magnitude values and if an amplitude of a magnitude value is greater than a threshold, then the mobile device decreases a confidence value associated with the corresponding directional value.

### CROSS REFERENCE TO RELATED APPLICATIONS

This non-provisional application claims the benefit of provisional application No. 61/584,171 filed on Jan. 6, 2012, entitled “Systems and Methods for Reliable Motion Control of Virtual Tour Applications”, which application is incorporated herein in its entirety by this reference.

### BACKGROUND

The present invention relates to systems and methods for reliably detecting motion control of mobile devices executing virtual tour applications.

Many mobile devices, including computer tablets and smartphones, rely on either one or more motion detecting devices such as gyroscopes, accelerometers and/or magnetometers, to detect motion of the device in the X, Y and/or Z axes for executing software applications.

Conventionally, gyroscopic technology enable these devices to measure their own angles of rotation across X, Y and Z axes. In some devices though, the inclusion of gyroscopic technology is cost-prohibitive and/or consumes excessive battery power. Hence, some devices, especially the smaller devices, such as smartphones, rely on a combination of magnetometer and accelerometer data values (from integrated technologies), to yield a similar spatial understanding of the mobile device's angles of rotation. However, magnetometers are often unreliable when used near any device or structure that may itself be magnetized and/or generates an electromagnetic field.

It is therefore apparent that an urgent need exists for reliably processing data values from magnetometers embedded in mobile devices. This improved processing of data values enables these devices to provide reliable angular data values that a mobile device application such as a virtual tour application can rely on to produce a smooth flowing display.

### SUMMARY

To achieve the foregoing and in accordance with the present invention, systems and methods for motion control detection is provided. In particular, the systems and methods for reliably detecting motion control of mobile devices executing virtual tour applications.

In one embodiment, a computerized mobile device is configured to reliably detect angular rotations of the mobile device. The mobile device includes a magnetometer for generating directional values representing the respective angular rotations. The mobile device detects abrupt change(s) in additional directional values relative to the prior directional values, and if an abrupt change in an additional directional value is detected, then an appropriate weight is assigned to the additional data value.

In some embodiments, in addition to generating directional values, the magnetometer may also generate corresponding magnitude values. The mobile device evaluates the corresponding magnitude values and if an amplitude of a magnitude value is greater than a threshold, then the mobile device decreases a confidence value associated with the corresponding directional value.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a perspective view of a mobile device which uses magnetometer and accelerometer values to determine its own angles of rotation in accordance with one embodiment of the present invention;

FIG. 2 illustrates a mobile device held and rotated at approximate arm's length from the head of a user navigating a virtual tour;

FIG. 3 is a flow diagram illustrating detection and correction of abrupt changes in magnetometer values;

FIG. 4 is a graph and 4 scenarios which exemplify a mobile device as it is brought close to a magnetized structure, the impact this interference has on the device's unmodulated signal, and a more accurate signal which is attainable when device acceleration is applied as a means of modulation;

FIG. 5 is a graph and 4 scenarios which exemplify a mobile device as it is brought close to a magnetized structure, the impact this interference has on the device's unmodulated signal, and a more accurate signal which is attainable when direction of the magnetic field is considered as a factor in modulation;

FIG. 6 is a flow diagram illustrating detection of simple amplitude changes in magnetometer values;

FIG. 7a is a graph which exemplifies the signal produced by a mobile device as it is rotated about the Z-Axis without the presence of magnetic interference and the resulting data which is yielded when device acceleration is applied as a means of modulation; and

FIG. 7b is a graph which exemplifies the signal produced by a mobile device as it is rotated about the Z-Axis without the presence of magnetic interference and the resulting data which is yielded when device acceleration and direction of magnetic signal are applied together as a means of modulation.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

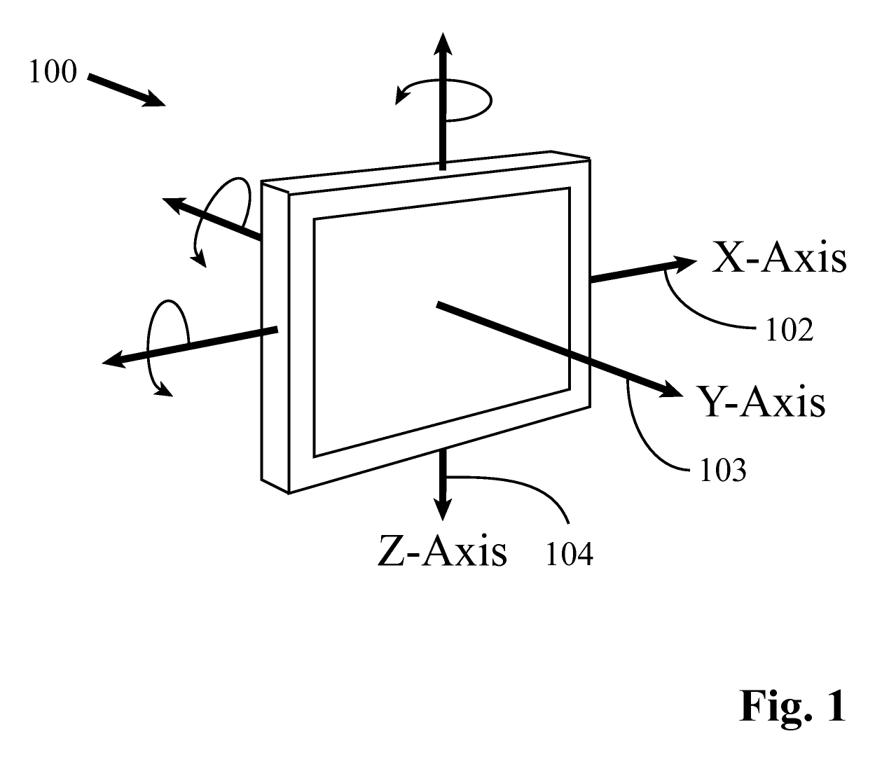

The present invention relates to systems and methods for reliably detecting motion control of mobile devices executing virtual tour (herein after also referred to as “VT”) applications. Note that the term “mobile device” is intended to include all portable electronic devices including cellular phones, computerized tablets, cameras, and hand-held gaming devices. To facilitate discussion, FIG. 1 shows a perspective view of a mobile device 100 which utilizes magnetometer and accelerometer values to determine angular rotation of the device in accordance with one embodiment of the present invention.

In this embodiment, mobile device 100 includes an accelerometer (not shown) which typically measures linear motion along X-Y, X-Z and Y-Z planes, and a magnetometer (not shown) which typically measures rotation around X-Axis 102, Y-Axis 103 and Z-Axis 104.

Suitable accelerometers and magnetometers for mobile device 100 are commercially available from a variety of manufacturers including ST Electronics Ltd of Berkshire, United Kingdom, AKM Semiconductor Inc. of San Jose, Calif., and InvenSense Inc. of Sunnyvale, Calif.

While a magnetometer is a relatively inexpensive and accurate method for measuring relative and/or absolute angular rotations relative to the Earth's magnetic field, magnetometer readings can be easily corrupted from interferences caused by magnetized structures or devices, or from electromagnetic fields generated by electrical/electronic devices such as electric motors and cathode ray displays. These interferences and disturbances can cause the magnetometer to generate erroneous values by altering the magnetometer's primary point of reference which is based on the normal (magnetic) North-South orientation of the Earth's magnetic field.

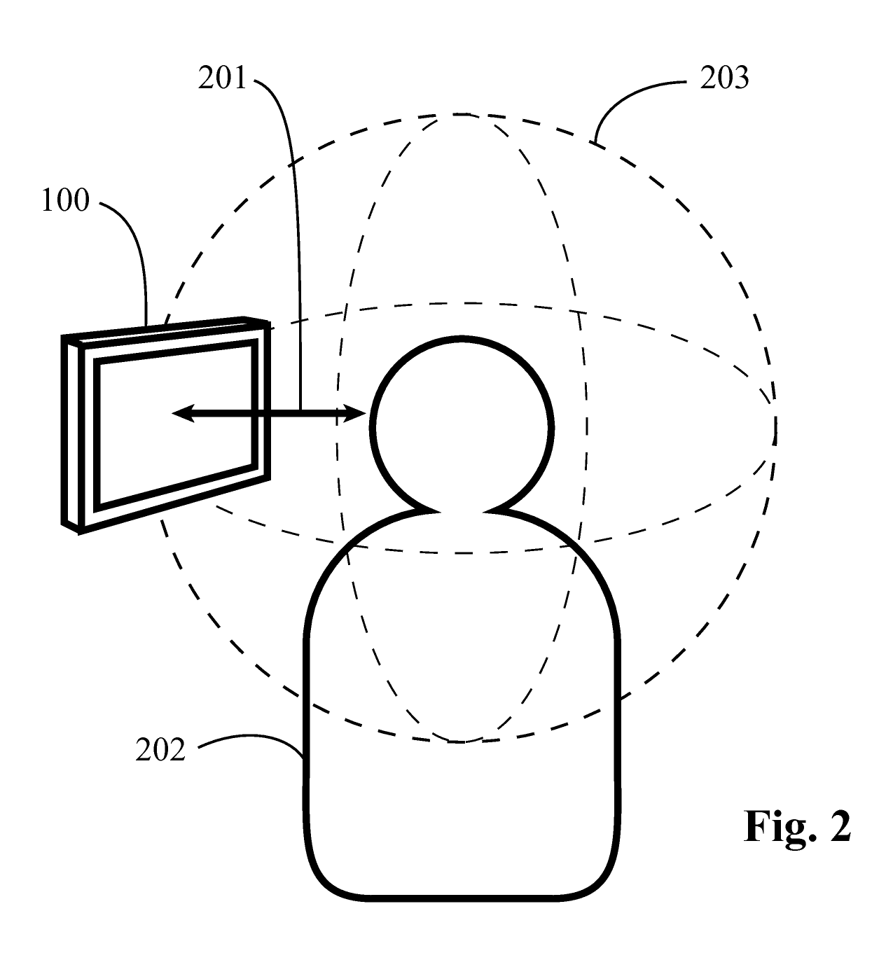

For example, as illustrated in FIG. 2, in order to significantly reduce the occurrence of disconcerting display anomalies due to the above-described phenomenon of erroneous magnetometer values caused by interferences, virtual tour viewing on mobile devices may be supported by the following strategy; understanding that mobile device 100 is likely to be held approximately 9-18 inches (arm's length 201) from the head of a viewing user 202, and rotated about 203 the user's head, rotational acceleration around all three axes can be calculated using an optional accelerometer (not shown) in mobile device 100 (in place of or in addition to the magnetometer).

The generally more reliable nature of accelerometer values makes them suitable for use in modulating the motion conveyed by mobile device 100's magnetometer. The onset of linear acceleration may indicate that rotational motion is occurring, while the absence of acceleration may indicate that the device is likely stationary—and thus any suggestion of large motions from mobile device 100's magnetometer without the presence of acceleration may be treated as erroneous and not conveyed to the user. In other words, significant changes from the magnetometer without acceleration may indicate a false reading which can be ignored.

Hence many possible motion detection strategies, e.g., acceleration detection techniques for mobile device 100 can be implemented, including the following exemplary techniques, alone and in combination, to reliably recognize a significant change in motion of mobile device 100.

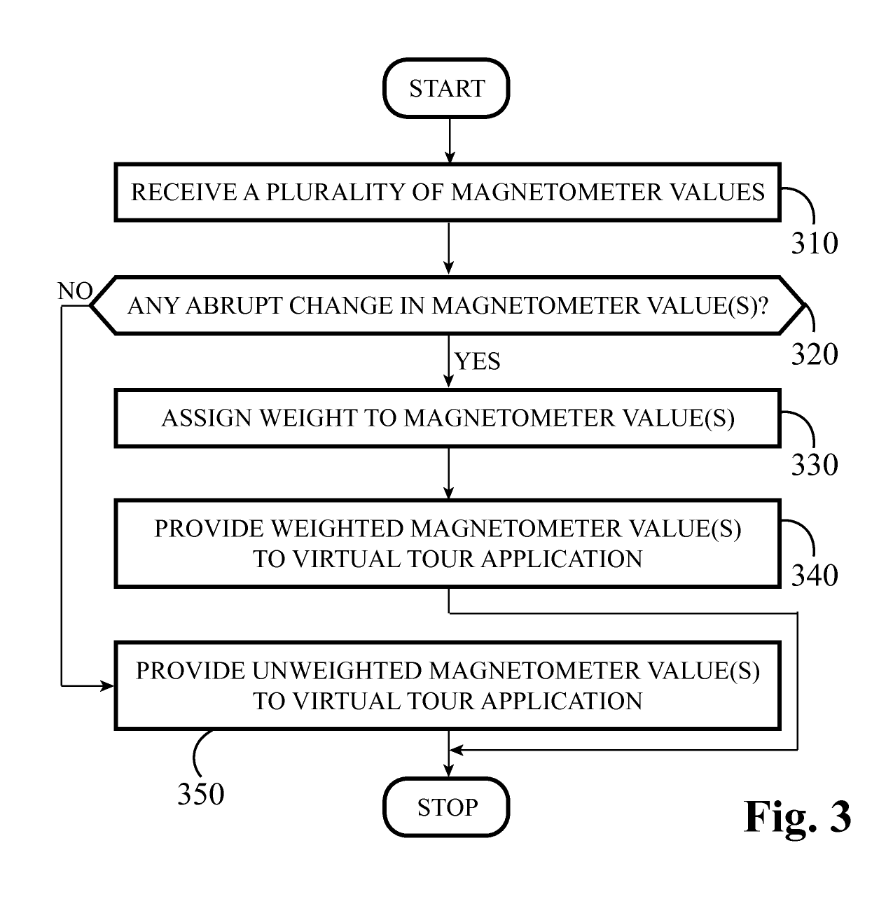

In some embodiments, as illustrated by the flow diagram FIG. 3, mobile device 100 may continually monitor magnetometer directional values so as to recognize any significant changes, e.g., any abrupt changes, in the rate of rotation and/or the rotational direction (steps 310, 320).

One possible presumption is that abrupt differences in rotational direction value (magnetic bearing) are likely caused by external magnetic interferences—as opposed to actual sudden rotational acceleration in mobile device 100. Accordingly, the trust given to a specific magnetometer data value can be assigned in the form of an appropriate weight (up to, for example, a maximum of 100%) depending on its variance from the plurality of preceding directional values (step 330). If trust is relatively high, then the most recent directional value from the magnetometer can be used (step 350). Conversely, if trust is relatively low, then the directional value may revert to the last trusted heading based on the previous directional value(s) and/or the weighted most recent directional value (step 340). An exemplary illustrative pseudo-code follows:

heading(loop) = last_trusted_heading * (1−mag_trust) + sensor( ) *
mag_trust;
if(mag_trust > .5)
last_trusted_heading = previous_heading( );
end

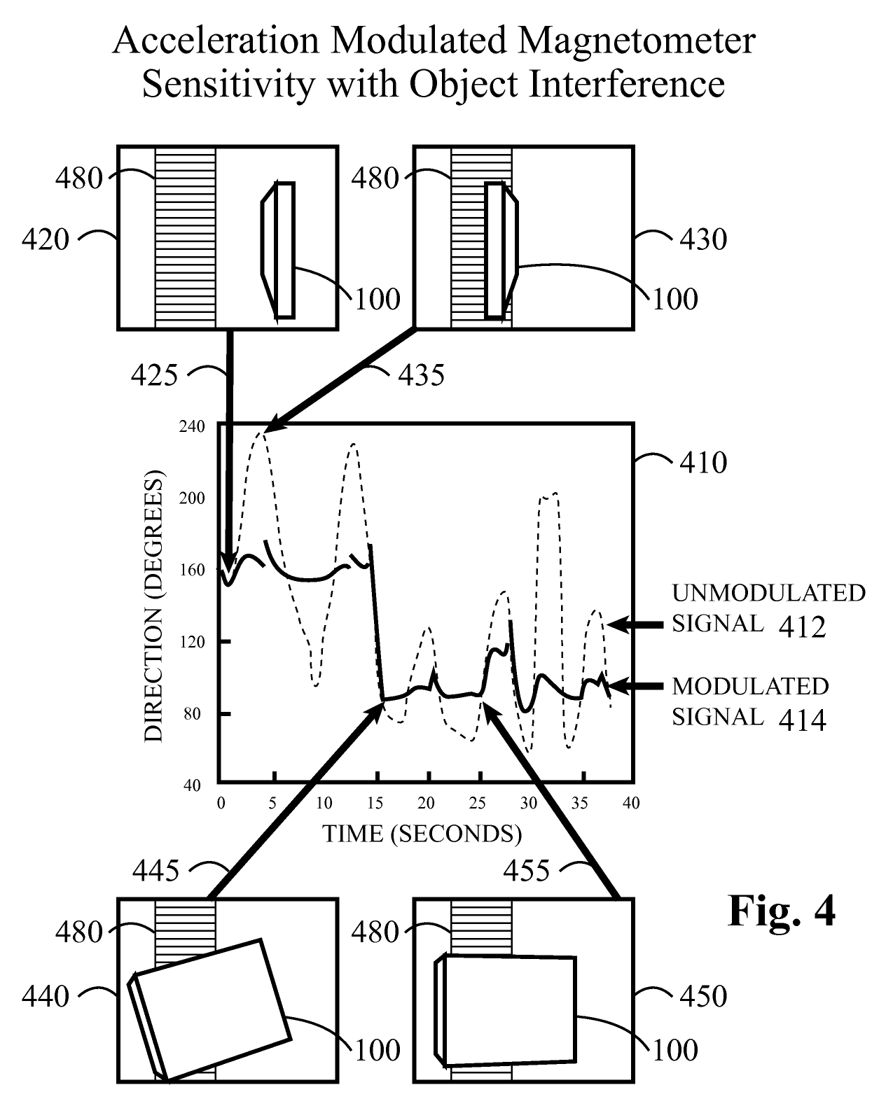

As discussed above and illustrated by the graph 410 of FIG. 4, in some embodiments, directional values provided by magnetometer may be modulated by corresponding accelerometer values based on consistency between magnetometer directional values and accelerometer values. Exemplary unmodulated directional signal trace 412 from magnetometer, and the corresponding modulated directional signal trace 414 as modulated by the accelerometer are both shown.

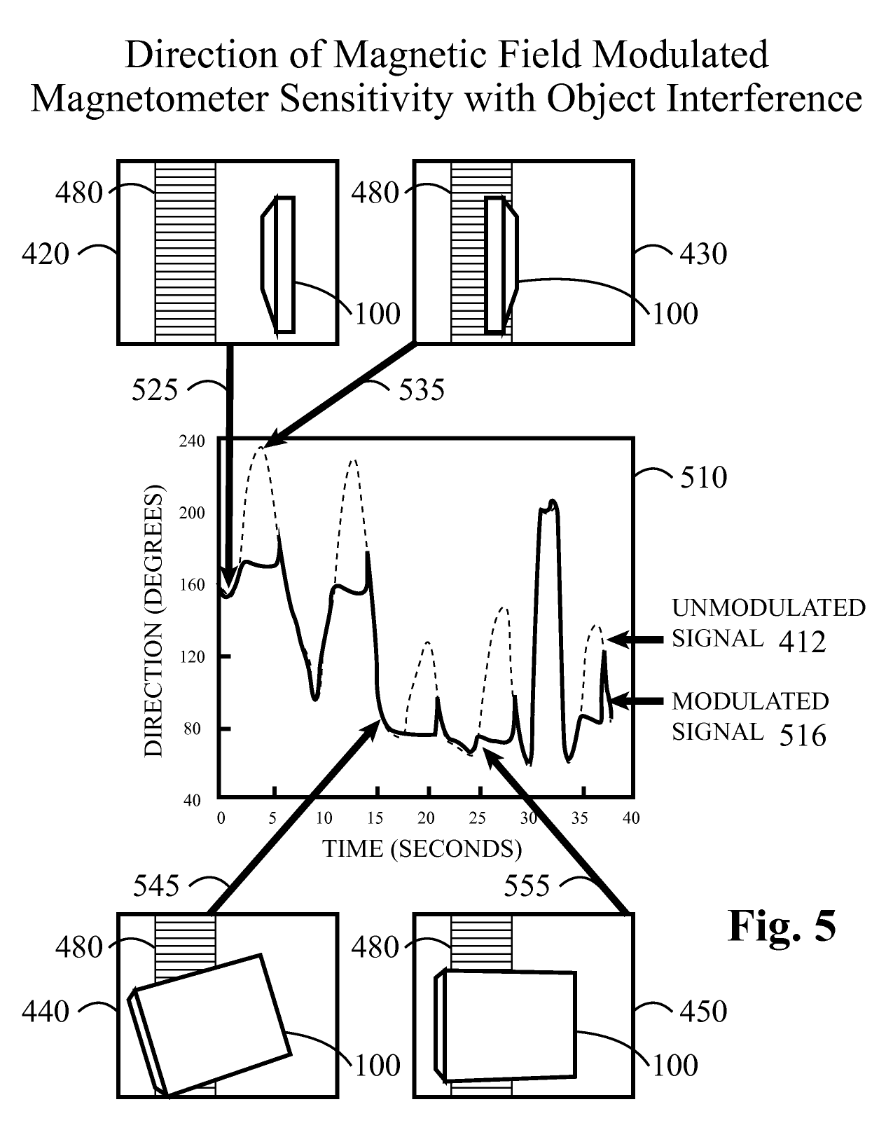

Referring to both the modulated magnetometer directional signal 516 of FIG. 5 and flow diagram of FIG. 3, graph 510 illustrates exemplary magnetometer directional values as mobile device 100 is accelerating at a perpendicular angle while moving from scenario 420, relative to a magnetized structure 480, and as mobile device 100 is accelerating at a perpendicular angle near magnetized structure 480 as shown in scenario 430. Graph 510 also illustrates modulated directional signal 516 as mobile device 100 accelerates at a parallel angle from scenario 420 to scenario 450.

These exemplary directional values illustrate how magnetometer of mobile device 100 can be greatly influenced by the presence of the magnetized structure 480 when reporting headings (see directional data points 535, 555). Hence, by leveraging the rate of acceleration as provided by accelerometer of mobile device 100 to moderate magnetometer directional values, a much more reliable heading may be ascertained.

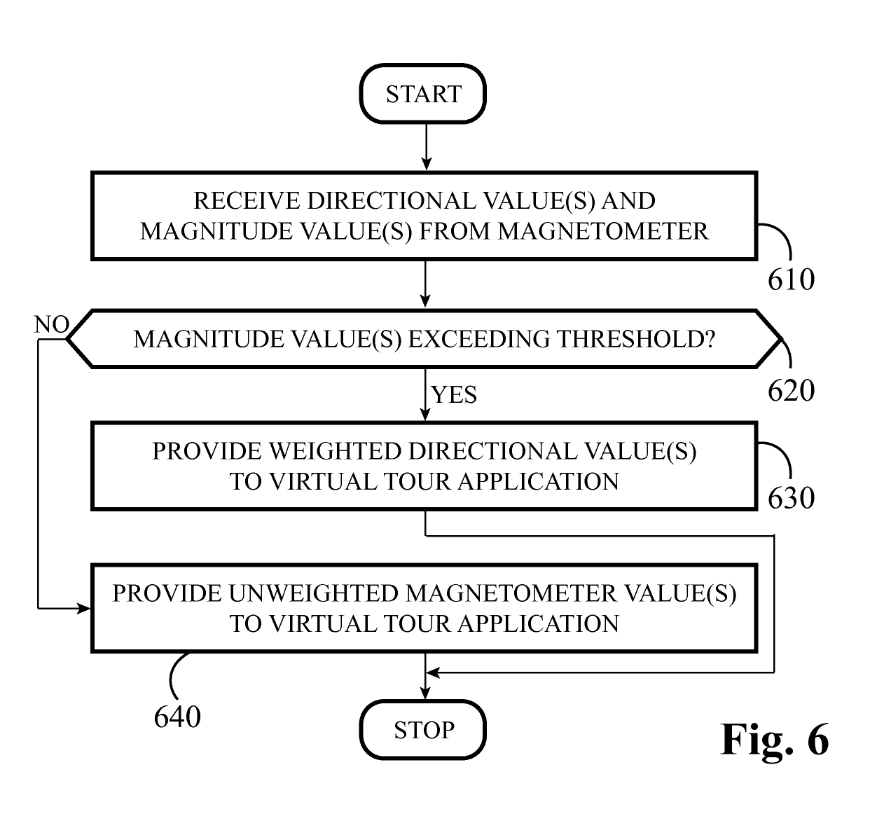

In some embodiments as illustrated by the flow diagram of FIG. 6, mobile device 100 can be configured to recognize significant amplitude change(s) in magnetometer value(s) as the magnitude of directional values are received and examined (steps 610, 620). This strategy is based on the assumption that magnetic interference caused by magnetized object(s) or magnetic field(s) are likely to dominate the Earth's magnetic field proximate to mobile device 100. As such, whenever magnetic interference is present, the magnitude of the proximate magnetic field is likely to increase substantially. This increase in the proximate magnetic field can be used as an indication of how accurate the directional values from the magnetometer are likely to be. By adjusting the level of trust associated with the magnetometer based on its magnitude, interference can largely be mitigated.

Accordingly, if the total signal from the magnetometer is less than a given threshold, then trust weight is increased (up to for example 100%) (step 630). Conversely if the magnitude value(s) is greater than a specified threshold, trust is decreased (reduced to, for example, a minimum of 0%) and a significant change is recognized (step 640). The weights can be stored and compared for a moving finite time window (for example an approximately 500 milliseconds time window). The specific gains that affect the rate the trust is changed are based on the data rate of the magnetometer of mobile device 100. Exemplary pseudo-code follows:

```
if(sqrt(device(1).\hat{ }2+device(2).\hat{ }2+device(3).\hat{ }2)<MAG_THRESHOLD)
  mag_trust = mag_trust*0.9 + 0.1;
else
  mag_trust = mag_trust*0.95;
end
```

In sum, as illustrated by chart 510, several of the large data spikes, e.g. spike 535, in the magnetic heading (caused by magnetic interference of object 480) are almost entirely reduced, while other un-modulated or lightly-modulated spikes continue to be recognized. Hence, this technique should also provide reliable directional values in the absence of magnetic interference. Based on these exemplary results, this technique should not cause significantly misleading readings in the presence of magnetic interference, but should be able to significantly reduce the large fluctuations associated with magnetic interference(s).

The above-described approaches may be adapted for other sensors (such as an accelerometer measuring acceleration). Another exemplary pseudo-code follows:

```
if(abs(device_sensor(loop,2)−device_sensor(loop-
1,2))>ACC_THRESHOLD)
  mag_trust = mag_trust*0.9 + 0.1;
else
  mag_trust = mag_trust*0.99;
end
```

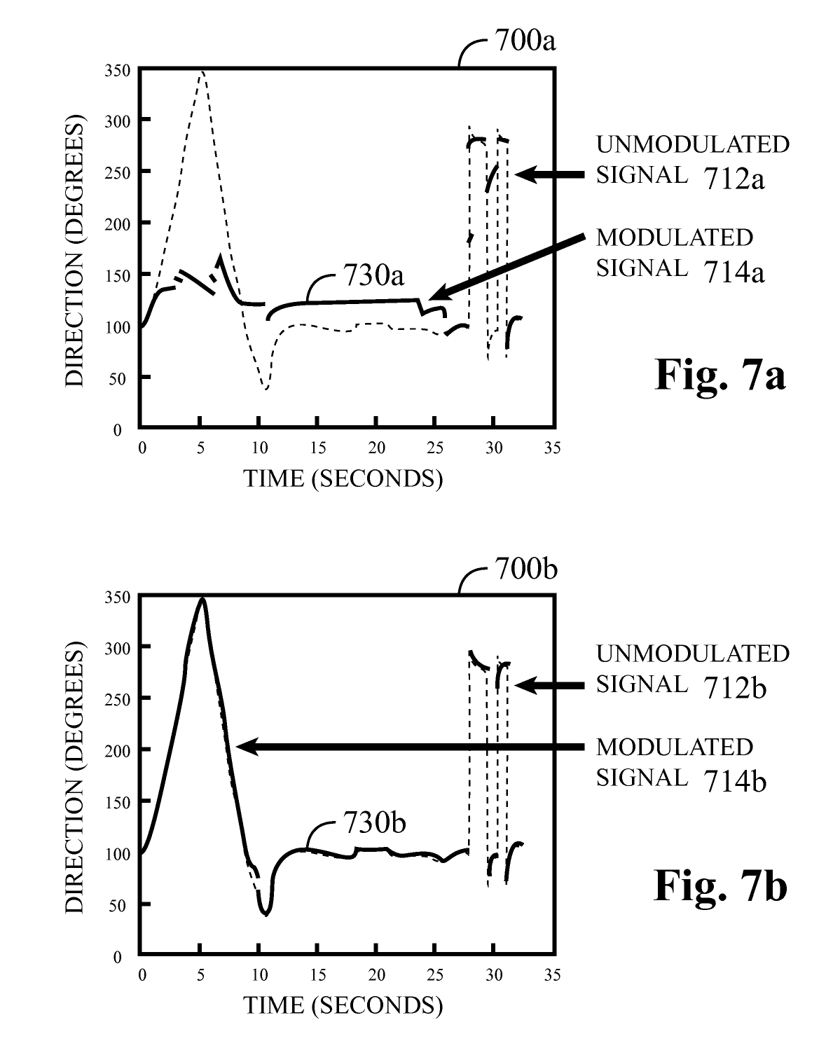

When exclusively employing the technique described above (acceleration modulated readings), false positives can have a higher likelihood of occurring. FIG. 7a shows exemplary data 700a as mobile device 100 is rotated 270 degrees about Z-Axis 104 without any magnetic interference present. In this example, the data suggests that mobile device 100 was not rotating for the first 25 seconds 730a, though in reality it was. Nevertheless, the mobile device 100 was able to track sudden changes at around 30 seconds, even though these motions are not typical of a user. In other words, this technique enables mobile device 100 to fairly successfully recognize interference, and in recognizing radical—but actual—rotation, but is less effective alone in recognizing moderate actual rotation.

When both techniques as described above are employed in combination, (acceleration modulated readings combined with direction of magnetic field moderated rotation), the exemplary results 700b as shown in FIG. 7b show significant improvement over employing a single technique. As mobile device 100 is rotated 270 degrees about Z-Axis 104 without any magnetic interference present, moderated data presented a nearly flawless interpretation 730b of the actual rotation performed, regardless of whether the actual motion was moderate or radical.

In sum, the present invention provides systems and methods for reliably detecting motion control of mobile devices executing virtual tour applications. The advantages of such a system include partial immunity from external magnetic interferences caused by the environment or other devices, and the ability to consistently generate smooth viewing experiences within virtual tours.

While this invention has been described in terms of several embodiments, there are alterations, modifications, permutations, and substitute equivalents, which fall within the scope of this invention. It should also be noted that there are many alternative ways of implementing the methods and apparatuses of the present invention, for example in hardware and/or in software or combinations thereof. It is therefore intended that the following appended claims be interpreted as including all such alterations, modifications, permutations, and substitute equivalents as fall within the true spirit and scope of the present invention.

What is claimed is:

1. A computerized method for reliably detecting an angular rotation of mobile device having a magnetometer, the mobile device configured to be hand-held by a user, the method comprising:
receiving a plurality of directional values from a magnetometer of a mobile device;
receiving an additional directional value from the magnetometer;
detecting an abrupt change in the additional directional value relative to the plurality of directional values; and
if the abrupt change in the additional directional value is detected, then assigning an appropriate weight to the additional data value.

2. The method of claim 1 further comprising providing a weighted directional value to a virtual tour application executing on the mobile device.

3. The method of claim 1 wherein the detection of the abrupt change includes detecting a rate of change of the additional directional value.

4. The method of claim 3 wherein the detection of the rate of change includes detecting a rate of change that is higher than a threshold.

5. The method of claim 3 wherein the weight assigned to the additional directional value is proportionate to the rate of change.

6. The method of claim 1 further comprising receiving a corresponding plurality of accelerometer values from an accelerometer of the mobile device, and evaluating consistency between the plurality of directional values and the plurality of accelerometer values.

7. The method of claim 6 further comprising modulating the plurality of directional values based on the consistency between the plurality of directional values and the plurality of accelerometer values.

8. A computerized method for reliably detecting an angular rotation of mobile device having a magnetometer, the mobile device configured to be hand-held by a user, the method comprising:
receiving at least one directional value and at least one corresponding magnitude value from a magnetometer of a mobile device;
evaluating the at least one magnitude value; and
if an amplitude of the at least one magnitude value is greater than a threshold, then reducing a confidence value associated with the at least one of directional value.

9. The method of claim 8 further comprising providing the at least one directional value with the associated confidence value to a virtual tour application executing on the mobile device.

10. The method of claim 8 further comprising receiving at least one corresponding accelerometer value from an accelerometer of the mobile device, and evaluating consistency between the at least one directional value and the at least one corresponding accelerometer value.

11. The method of claim 10 further comprising modulating the at least one directional value based on the consistency between the at least one directional value and the at least one corresponding accelerometer value.

12. A computerized mobile device configured to reliably detect an angular rotation of mobile device having a magnetometer, the mobile device configured to be hand-held by a user, the mobile device comprising:
a magnetometer configured to generate a plurality of directional values and to generate an additional directional value; and
a processor configured to detect an abrupt change in the additional directional value relative to the plurality of directional values, and if the abrupt change in the additional directional value is detected, then to assign an appropriate weight to the additional data value.

13. The mobile device of claim 12 wherein the processor is further configured to provide a weighted directional value to a virtual tour application executing on the mobile device.

14. The mobile device of claim 12 wherein the detection of the abrupt change includes detecting a rate of change of the additional directional value.

15. The mobile device of claim 14 wherein the detection of the rate of change includes detecting a rate of change that is higher than a threshold.

16. The mobile device of claim 14 wherein the weight assigned to the additional directional value is proportionate to the rate of change.

17. The mobile device of claim 12 further comprising an accelerometer and wherein the processor is further configured to receive a corresponding plurality of accelerometer values from the accelerometer, and to evaluate consistency between the plurality of directional values and the plurality of accelerometer values.

18. The mobile device of claim 17 wherein the processor is further configured to modulate the plurality of directional values based on the consistency between the plurality of directional values and the plurality of accelerometer values.

19. A computerized mobile device configured to reliably detect an angular rotation of mobile device having a magnetometer, the mobile device configured to be hand-held by a user, the mobile device comprising:
a magnetometer configured to generate at least one directional value and at least one corresponding magnitude value; and
a processor configured to evaluate the at least one magnitude value, and if an amplitude of the at least one magnitude value is greater than a threshold, then to reduce a confidence value associated with the at least one of directional value.

20. The mobile device of claim 19 wherein the processor is further configured to provide the at least one directional value with the associated confidence value to a virtual tour application executing on the mobile device.

21. The mobile device of claim 19 further comprising an accelerometer and wherein the processor is configured to receive at least one corresponding accelerometer value from the accelerometer, and to evaluate consistency between the at least one directional value and the at least one corresponding accelerometer value.

22. The mobile device of claim 21 wherein the processor is further configured to modulate the at least one directional value based on the consistency between the at least one directional value and the at least one corresponding accelerometer value.
